(19) United States
(12) Patent Application Publication
(10) Pub. No.: US 2013/0167844 A1
(43) Pub. Date: Jul. 4, 2013

(54) SUPPORT STAND FOR USE DURING REMOVAL OF AN ORTHOPEDIC CAST ON AN EXTREMITY

(71) Applicant: Olarewaju Oladipo, Canton, MA (US)

(72) Inventor: Olarewaju Oladipo, Canton, MA (US)

(21) Appl. No.: 13/720,025

(22) Filed: Dec. 19, 2012

Related U.S. Application Data
(63) Continuation-in-part of application No. 13/541,989, filed on Jul. 5, 2012.
Application No. 13/541,989 is a continuation-in-part of application No. 13/342,054, filed on Jan. 1, 2012.
(60) Provisional application No. 61/616,113, filed on Mar. 27, 2012.
(60) Provisional application No. 61/674,448, filed on Jul. 23, 2012.

(51) Int. Cl. A61G 99/00

(52) U.S. Cl. CPC A61G 99/00
USPC 128/845

(57) ABSTRACT

A cast support system for removing a cast and methods of removing a cast described herein have the advantage over prior art devices and methods by permitting hands free, improved immobilization of the cast on a patient's body member, and patient comfort while the cast is being removed from the patient's body.

### CROSS-REFERENCE TO RELATED APPLICATIONS

This application is a continuation-in-part of and claims priority to and the benefit of U.S. patent application Ser. No. 13/541,989, filed Jul. 5, 2012, which is a continuation-in-part of and claims priority to and benefit of U.S. patent application Ser. No. 13/342,054, filed Jan. 1, 2012, and U.S. Provisional Application Ser. No. 61/616,113, filed Mar. 27, 2012, and claims priority to and benefit of U.S. Provisional Application Ser. No. 61/674,448, filed Jul. 23, 2012, the contents of each are incorporated herein by reference in their entirety.

### TECHNICAL FIELD OF THE INVENTION

The present invention relates to the field of orthopedics, particularly the removal of casting materials applied to a part of the body.

### BACKGROUND OF THE INVENTION

in using a cast removal device, e.g., described in U.S. patent application Ser. No. 13/541,989. U.S. provisional application Ser. No. 61/616,313 or U.S. patent application Ser. No. 13/342,054, to remove a east from a patient's body member, an abrasive elongated cord as described therein is positioned in a housing and reciprocally pulled to and fro upward by a healthcare provider gripping a pair of handles joined at the ends of the elongated cord to cut through the cast. In cutting the cast, an upward pull or traction is applied from under the cast and through the east until the cast is entirely cut through by the abrasive elongated cord as it is pulled to and fro to cut through the east. While applying upward traction to the abrasive elongated cord to cut the cast, the patient's body member that bears the cast is forcibly pulled upward from a resting position, making it uncomfortable for the patient and difficult to cut through the cast with the abrasive elongated cord without counter resistance. To limit the upward pull on the part of the body, an assistant holds down the carted patient's body member firmly on a support to provide counter-resistance to the upward force.

An advantage of the cast removal support stand of the current invention is that it eliminates the need for an assistant to hold the patient's body member down while upward force is applied to the casted body member during the process of cast removal. The east removal support stand will also keep the casted part of the body member comfortably at rest while the abrasive wire of the referenced invention cuts through the cast.

### SUMMARY OF THE INVENTION

Methods of supporting a cast applied to a body member for cast removal by a cast removal device described, for example, in U.S. Ser. No. 13/541,989, U.S. provisional application 61/616,313, or U.S. Ser. No. 13/342,054, a cast support system for removing a cast, and methods of removing a cast described herein have the advantage over prior art devices and methods by permitting hands free, improved immobilization of the cast on a patient's body member, and patient comfort while the cast is being removed from the patient's body member using the cast removal device, for example, the device described in the U.S. Ser. No. 13/541,989 or U.S. provisional application 61/616,313 or the U.S. Ser. No. 13/342,054.

In one aspect, the invention comprises a cast support system having a planar horizontal support member such as a table comprising a top surface and a bottom surface and at least one hole, preferably a slot, extending from the top surface of the planar horizontal support member to the bottom surface of the planar horizontal support member. In one embodiment, the height of the planar horizontal support member may be raised or lowered by an adjustable, telescoping pole that is joined to and extends from the bottom surface of the planar horizontal member to a base at the bottom of the cast support system.

The base of the cast support system includes horizontal extensions upon which a healthcare provider can place one's feet and apply counter weight to an upward force applied to the casted body member by the healthcare provider to cut the cast.

The cast support system according to the invention described herein includes at least one clamp, preferably two clamps, each clamp having a first half-clamp and a second half-clamp. Each half-clamp comprises an engagement face, e.g., a face with a radius. In one embodiment of the invention, only one half-clamp is moveable horizontally on the top surface of the planar horizontal support member towards the second half-clamp. In another embodiment, the second half-clamp is replaced with a block that is fixed or moveable horizontally on the top surface of the planar horizontal support member.

The cast support system of the invention further comprises a ratchet pole. The ratchet pole has a free end, a fixed end, and an intermediate portion positioned between the free end and the fixed end. The intermediate portion is vertically slideable perpendicular to the top surface of the planar horizontal member and non-rotatably positioned in a hole in of the planar horizontal support member. The ratchet pole may be cylindrical or may have a flat side. In one embodiment, when one of the ratchet pole and the hole have a shape such as cylindrical or round, as the case may be, the other of the ratchet pole and hole have another shape such that the ratchet pole is non-rotable within the hole. The free end of the ratchet pole is positioned under the bottom surface of the planar horizontal support member and the fixed end of the ratchet pole is positioned above the top surface of the planar horizontal support member. The free end of the ratchet pole is optionally removably joined to a base fixed to the bottom surface of the planar horizontal support member or positioned on the top surface of the planar horizontal support member.

The cast support system of the invention further includes a ratchet having a longitudinal axis substantially parallel to the top surface of the planar horizontal support member, an upper toothed portion slideably moveable parallel to the top surface of said planar horizontal support member, and a lower toothed portion. The upper toothed and lower toothed portions are meshable, the tooth of one portion of the ratchet fitting between teeth of the other portion of the ratchet.

The ratchet is positioned on the upper surface of the planar horizontal support member above or hole or slot, e.g., the first hole, the long axis of the ratchet being substantially parallel to the top surface of the planar horizontal member, optionally perpendicular to a long axis of the planar horizontal support member and/or to a long axis of the patient's casted body member. The ratchet lower toothed portion is joined to the fixed end of the ratchet pole above the top surface of the planar horizontal member. In one embodiment of the invention, the first half-clamp is joined to the top surface of the ratchet upper portion.

In one embodiment, a second ratchet having a second half-clamp is positioned opposite the first ratchet and opposite the first hole or slot on the other side of the planar horizontal member and its longitudinal axis is aligned with the longitudinal axis of the first ratchet such that when the first and second half-clamps are slideably moved towards one another on the top surface of the planar horizontal support member, the engagement face of each half clamp meet or alternatively, form a gap between the engagement face of the first and the engagement face of the second half-clamp or, optionally, the engagement face of a block.

The invention described herein may include one, two or more clamps according to the invention, each clamp positioned successively along the long axis of the patient's casted body member.

A reciprocal locking-unlocking mechanism, as known to one skilled in the art, such as a spring lock, reciprocally locks and unlocks the ratchet upper toothed portion to the ratchet lower toothed portion.

In another aspect, the invention is a method for supporting a patient's casted body member for removal of the cast. In one embodiment, a cast removal device described in U.S. Ser. No. 13/541,989, U.S. provisional application Ser. No. 61/616,313, or U.S. Ser. No. 13/342,054, is used for removing the cast held in the cast removal support system described above.

To remove the cast, according to the invention, a patient's casted body member is placed on the planar horizontal support member of the cast removal support system described above. The casted body member is positioned perpendicular to the longitudinal axis of the one or more ratchets. A ratchet and a half-clamp are slideably positioned vertically by adjusting the ratchet pole vertically to align said patient casted body member in a position that is substantially parallel to the top surface of the planar horizontal support member.

The top portion of at least one ratchet is ratcheted horizontally parallel to the ratchet bottom portion to move the first half-clamp joined to the upper portion of the ratchet against the cast on the patient's body member. The upper portion of the ratchet is locked into place by a locking mechanism such as a latch. In one embodiment, a block or a second half clamp is positioned against the opposite side of the cast opposite to the first half-clamp to substantially fix the patient body member and prevent movement of the patient's body member upward when an upward force is applied to the patient casted body member.

After the patient's casted body member is fixed in position on the cast removal support system, a cast removal device described in, e.g., U.S. Ser. No. 13/541,989, U.S. provisional application No. 61/616,313, or U.S. Ser. No. 13/342,054, is used to cut through the cast by applying upward force on the fixed-in-place cast. The healthcare provider may utilize his or her weight against the upward force on the cast during cast removal by stepping on the extensions on the base of the cast removal support system and apply body counter-weight to the upward force.

### BRIEF DESCRIPTION OF THE FIGURES

FIG. 1A illustrates a plan view of one embodiment of the cast support system according to the invention.

FIG. 1B illustrates a perspective view of an exemplary clamp and ratchet according to one embodiment of the cast support system of the invention.

FIG. 1C illustrates a perspective view of an exemplary clamp and ratchet according to another embodiment of the cast support system of the invention.

FIG. 2A illustrates a perspective view of an exemplary half-clamp and a ratchet according to one embodiment of the invention.

FIG. 2B illustrates an exploded view of the half-clamp and ratchet illustrated in FIG. 2A.

### DESCRIPTION OF THE INVENTION

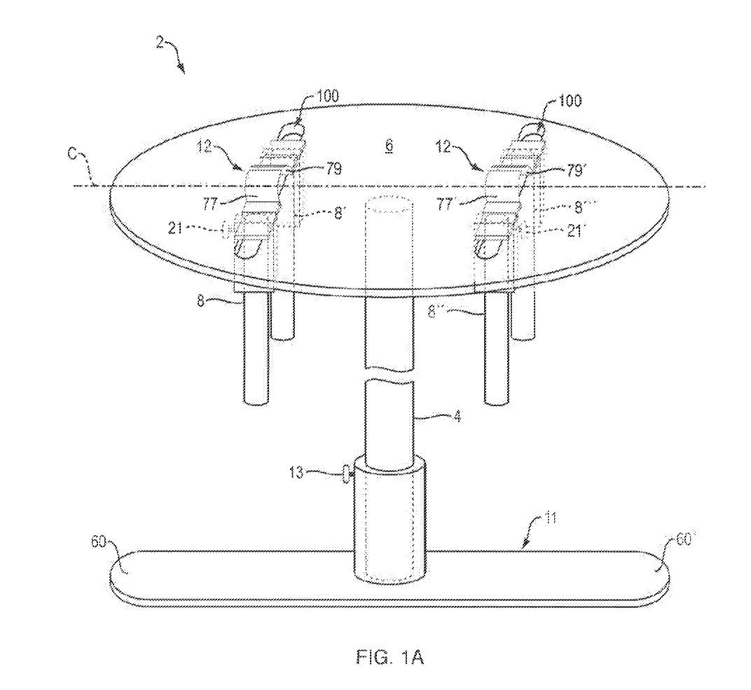

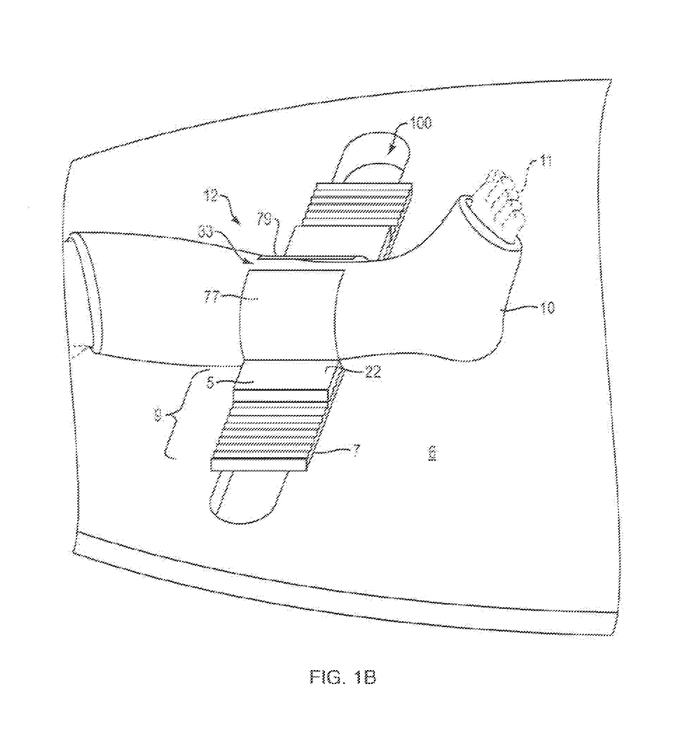

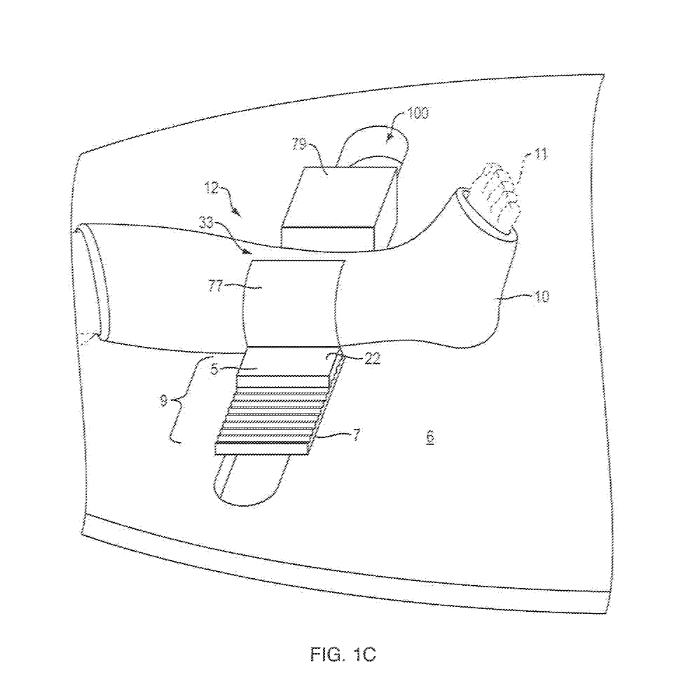

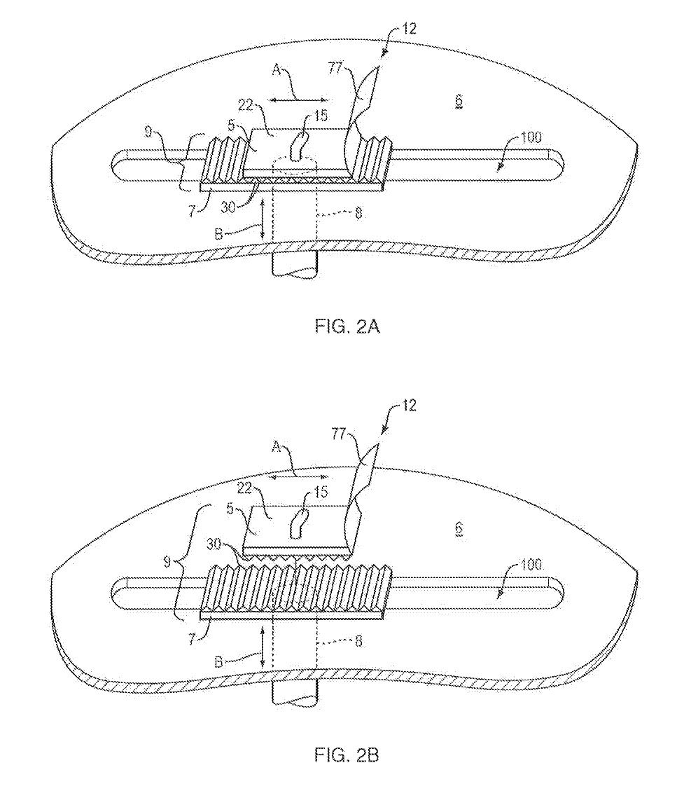

Referring to FIG. 1A, generally, the cast support system 2 according to the illustrated embodiment of the invention, has a horizontal planar support member 6, e.g., a platform or table top, one or more adjustable clamps 12, each clamp 12 including a first half-clamp 77 and a second half-clamp 79 or block that securely encloses part or the whole circumference of the patient's casted body member 11. In the preferred embodiment of this invention, the adjustable half-clamps 77, 79 partially enclose the body member such as an arm, leg, or other extremity, bearing a cast 10, as illustrated in FIG. 1B optionally leaving a gap 33 between the half-clamps 77, 79 through which an elongated abrasive cord described, for example, in U.S. Ser. No. 13/541,989, U.S. provisional application No. 61/616,313, or U.S. Ser. No. 13/342,054, can be pulled to and fro to cut through the cast applied to the body member 11. Referring to FIGS. 2A, 2B the adjustable half-clamps 77, 79 of the present invention (only half clamp 77 is illustrated in FIGS. 2A, 2B) are adjusted by sliding the half-clamp 77 (or 79) joined to the top surface 22 of an upper ratchet portion 5 of a ratchet 9 and a lower ratchet portion 7 in a horizontal plane parallel to the top surface of the horizontal planar support member 6 indicated by arrow A and may be raised vertically indicated by arrow B by a ratchet pole 8 attached to the lower portion 7 of the ratchet 9.

Referring to FIGS. 2A and 2B, in one embodiment of the current invention, a multiplicity of lockable teeth 30 positioned on the bottom surface of the upper ratchet portion 5 and the top surface of the lower ratchet portion 7 provides the template for the half-clamps 77, 79 to be adjusted in a horizontal plane parallel to the top surface of the planar horizontal support member 6. The lower ratchet portion 7 is joined to a ratchet pole 8 that raises and lowers the ratchet 9 until the half-clamp fits snugly under and against the casted body member 10 maintaining the body member 11 in the desired position relative to the planar horizontal support member 6, preferably substantially parallel to the top surface of horizontal planar support member 6. The ratchet pole 8 is locked into position by a locking mechanism 21 known to one skilled in the art on a base 102 fixedly joined to the bottom surface of the planar horizontal support member 6 or above the top surface of the planar horizontal support member 6.

The planar horizontal support member 6 and the half-clamps 77, 79 may be padded with fabric, foam, or rubberized materials to avoid excessive pressure on the casted body member during cast removal.

Referring to FIG. 1A, in one embodiment of the cast removal support system 2 of the invention, the planar horizontal support member 6 is connected to a base 11 by a telescoping pole 4. The vertical telescoping pole 4 is adjustable by a means of a telescoping mechanism that varies the height of the support stand during use by raising and lowering the vertical telescoping pole 4. The vertical telescoping pole 4 is made of a sturdy construct so as to withstand the weight of the casted body member when the casted body member is positioned on it. The adjustable part of the telescoping pole 4 is secured in place with, for example, but not limited to one, or more screws 13 that tighten when turned and advanced inward. The cast removal support system 2 is preferably made of steel or steel alloys, although it can also be fabricated from wood and plastic composites.

In a particular embodiment of the invention, the base 11 of the cast removal support system 2 is generally of a shape and dimension such that it can be easily accessed and held down against the floor by the feet of the health care provider using the referenced cast removal device described herein. During cast removal, the base 11 of the cast removal support stand 2 is held securely by the feet of the user on left base extension 60 and right base extension 60′ to provide a counter-traction weight on the cast removal support system 2. An alternative embodiment of this invention requires the base 11 of the cast removal support system 2 to be bolted securely to the ground to offer the necessary counter-traction support. A weighted object can also be positioned on the base 11 to offer the same advantage.

In another embodiment of this invention, one of the half-clamps 77, 79 or block is rigidly fixed to the top surface of the platform 6, while the other half-clamp 77, 79 is non-fixed and is movable in a vertical and/or horizontal direction to support the casted body member positioned between it and the rigidly fixed half-clamp.

Referring to FIGS. 1A-1C and 2A, during the use of the cast removal support system 2, one or both of the half-clamps are moved horizontally by slideably operating the upper ratchet portion 5 towards the center C of the planar horizontal support member 6 until it fits snugly against a part of the outer circumference of the cast 10 on the body member 11. The upper ratchet portion 5 is held in position over the lower ratchet portion 7 by latch 15.

To manipulate the half-clamp in a vertical direction, the ratchet pole 8 is joined to the ratchet lower portion 7 and moved up or down vertically as indicated by arrow B to position the half-clamp 77 in the desired position. In a particular embodiment of the invention, the second half-clamp 79 of the clamp 12 is similarly moved in a vertical manner through a second hole or slot 100.

To use the cast removal support system 2 to remove a cast, for example, on a leg, the casted leg is positioned on the planar horizontal support member 6 aligned perpendicular to the long axis of the ratchet 9. One or both half-clamps 77, 79 are ratcheted inwards towards the center C of the planar horizontal support member against the casted body member 10. The upper ratchet portion 5 is latched to the lower ratchet portion 7 by latch 15 such that the casted body member 10 is held firmly in position between a first half-clamp 77 and a second slideable or fixed half-clamp, or a slideable or fixed block 79. The casted body member may be rotated such that the part of the cast that has a cast removal device described in, for example, U.S. Ser. No. 13/541,989, U.S. provisional application No. 61/616,313, or U.S. Ser. No. 13/342,054, aligns with the gap 33 between the half-clamps. The portion of the cast overlying the cast removal device is cut through as described in the applications Attached at A and B. After one side of the cast is divided with the elongated abrasive cord, the leg bearing the cast is rotated in an opposite direction to line up with the part of the east that has a second cast removal device. The cast covering the foot of the leg is removed while the leg is held stable on the planar horizontal support member 6 of the cast support system 2.

What is claimed is:

1. A cast support system, comprising:
a planar horizontal support member comprising a top surface and a bottom surface and a hole extending from the top surface of the planar horizontal member to the bottom surface of the planar horizontal member;
a first half-clamp;
a block, or, optionally a second half-clamp;
a ratchet pole, said pole comprising a free end, a fixed end, and an intermediate portion positioned between said free end and said fixed end, said intermediate portion non-rotatable in said hole wherein said intermediate portion of said pole extends through the hole and is moveable perpendicular to the top surface of said planar horizontal member, the free end of said pole positioned under the bottom surface of said planar horizontal member and the fixed end of said pole positioned above the top surface of the planar horizontal member;
a ratchet comprising a longitudinal axis, a lower toothed portion, an upper toothed portion slideably moveable horizontally parallel to said top surface of said planar horizontal support member and to said lower toothed portion, wherein the upper toothed and lower toothed portions are meshable, said ratchet positioned above said hole and said ratchet longitudinal axis positioned substantially parallel to the top surface of the planar horizontal support member, said ratchet lower toothed portion joined to said fixed end of said ratchet pole, and said upper toothed portion joined to said first half-clamp; and,
a locking mechanism for locking said upper toothed portion of said ratchet to said lower toothed portion of said ratchet.

2. A method for supporting a patient casted body member for cast removal, comprising:
providing a cast removal support system comprising,
a planar horizontal support member comprising a top surface and a bottom surface and a hole, said hole extending from the top surface of the planar horizontal support member to the bottom surface of the planar horizontal member, a first half-clamp, a block, or, optionally a half-clamp, a ratchet pole, said pole comprising a free end, a fixed end, and an intermediate portion positioned between said free end and said fixed end, said intermediate portion non-rotatable in said hole wherein said intermediate portion of said pole extends through the hole and moveable perpendicular to the top surface of said planar horizontal member, the free end of said pole positioned under the bottom surface of said planar horizontal member and the fixed end of said pole positioned above the top surface of the planar horizontal member, a ratchet comprising a longitudinal axis, a lower toothed portion, an upper toothed portion slideably moveable horizontally parallel to said top surface of said planar horizontal support member and said lower toothed portion, wherein the upper toothed and lower toothed portions are meshable, said ratchet positioned above said hole and said ratchet longitudinal axis arranged substantially parallel to the top surface of the planar horizontal support member, said ratchet lower toothed portion joined to said fixed end of said ratchet pole, and said upper toothed portion joined to said first half-clamp, and, a locking mechanism for locking said upper toothed portion of said ratchet to said lower toothed portion of said ratchet;
placing said first half-clamp against the cast of said patient casted body member;
slideably positioning said ratchet pole vertically to align said patient casted body member substantially parallel to the top surface of said planar horizontal member and locking said ratchet pole in said vertical position;
ratcheting said top portion of said ratchet horizontally parallel to the bottom portion of said ratchet until said first half-clamp and said block or, optionally, said second half-clamp substantially fix said patient body member from moving upward when an upward force is applied to the patient casted body member; and
removing said cast.
